(19) United States
(12) Patent Application Publication
(10) Pub. No.: US 2024/0036636 A1
(43) Pub. Date: Feb. 1, 2024

(54) PRODUCTION OF AND INTERACTION WITH HOLOGRAPHIC VIRTUAL ASSISTANT

(71) Applicant: SA Incubator LLC, Princeton, NJ (US)

(72) Inventors: Susan Press, Princeton, NJ (US); Alberto Washington, Princeton, NJ (US)

(21) Appl. No.: 18/346,854

(22) Filed: Jul. 5, 2023

Related U.S. Application Data
(63) Continuation-in-part of application No. 17/554,311, filed on Dec. 17, 2021, now abandoned.
(60) Provisional application No. 63/127,225, filed on Dec. 18, 2020.

(51) Int. Cl. G06F 3/01; G02B 30/56; G02B 5/32

(52) U.S. Cl. CPC G06F 3/011; G06F 3/016; G02B 30/56; G02B 5/32

(57) ABSTRACT

Disclosed is a method for producing and interacting with a holographic virtual assistant using an interactive display system, the method comprising: generating a first image of the holographic virtual assistant; displaying the first image using the interactive display system, wherein upon displaying, the holographic virtual assistant is produced in air; receiving at least one interaction input pertaining to an interaction between the holographic virtual assistant and a user of the interactive display system; generating at least one interaction output, based on the at least one interaction input; and controlling the interactive display system to provide the at least one interaction output to the user.

### CROSS-REFERENCE TO RELATED APPLICATIONS

This application is a continuation-in-part of U.S. patent application Serial Number U.S. Ser. No. 17/554,311, titled “INTERACTIVE DISPLAY SYSTEM AND METHOD FOR INTERACTIVELY PRESENTING HOLOGRAPHIC IMAGE” and filed on Dec. 17, 2021, which is also incorporated herein by reference.

### TECHNICAL FIELD

The present disclosure relates to methods for producing and interacting with a holographic virtual assistant using an interactive display system. The present disclosure also relates to computer program products for producing and interacting with a holographic virtual assistant using an interactive display system. The present disclosure also relates to interactive display systems that implement such methods.

### BACKGROUND

In the past few decades, extended reality (XR) technologies such as virtual reality (VR), augmented reality (AR), mixed reality (MR), and the like, have made exponential advancements in the way such technologies present visual environments to users of specialized devices. Presently, XR environments are experienced by the users using dedicated XR devices such as XR headsets, XR glasses, XR-based computing devices (such as XR-based smartphones or tablets), and the like. These XR devices act as a window through which the XR environments are viewed and therefore limit the users to be in proximity of these XR devices to be able to view the XR environments.

Despite recent advancements in XR technologies employing holography, existing techniques and equipment for providing a fully immersive experience in XR has several limitations associated therewith. Firstly, holographic images produced using the XR technologies employing holography can represent limited content, thereby restricting a range and variety of holographic experiences that can be offered to the user. Secondly, existing technologies enable very limited interaction between hologram and users of such devices, which provides a suboptimal usage experience (i.e., a non-immersive experience and/or a non-realistic experience).

Therefore, in light of the foregoing discussion, there exists a need to overcome the aforementioned drawbacks.

### SUMMARY

The aim of the present disclosure is to provide methods, computer program products and interactive display systems to provide a customized, natural and immersive experience to the user. The aim of the present disclosure is achieved by the methods and computer program products for producing and interacting with a holographic virtual assistant using an interactive display system and interactive display systems as defined in the appended independent claims to which reference is made to. Advantageous features are set out in the appended dependent claims.

Embodiments of the present disclosure substantially eliminate or at least partially address the aforementioned problems in the prior art, and facilitate users in effectively interacting with the interactive display system and enable use of the interactive display system in a variety of practical use case scenarios.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a flowchart depicting steps of a method for producing and interacting with a holographic virtual assistant using an interactive display system, in accordance with an embodiment of the present disclosure;

FIG. 2 illustrates a block diagram of an architecture of an interactive display system, in accordance with an embodiment of the present disclosure; and

FIGS. 3A and 3B illustrate exemplary perspective views of an environment in which an interactive display system is used, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a method for producing and interacting with a holographic virtual assistant using an interactive display system, the method comprising:
generating a first image of the holographic virtual assistant;
displaying the first image using the interactive display system, wherein upon displaying, the holographic virtual assistant is produced in air;
receiving at least one interaction input pertaining to an interaction between the holographic virtual assistant and a user of the interactive display system;
generating at least one interaction output, based on the at least one interaction input; and
controlling the interactive display system to provide the at least one interaction output to the user.

In the aforementioned method for producing and interacting with the holographic virtual assistant using the interactive display system, by generating and displaying the holographic virtual assistant in the air, a highly immersive, realistic, and engaging experience is created for the user. Furthermore, based on the interaction between the holographic virtual assistant and the user of the interactive display system, the holographic virtual assistant can generate the at least one interaction output, which is personalized as per requirements of the user. The interactive display system is controlled in a dynamic manner. Such interaction with the interactive display system is enabled synergistically by generating and displaying the first image, and facilitating natural and intuitive interactions between the holographic virtual assistant and the user in real time. The holographic virtual assistant is a tangible presence, which interacts with the user in a natural manner. The at least one interaction output is generated based on the at least one interaction input, thereby providing information, answering queries, and/or performing tasks based on preferences and needs of the user. There are no limitations regarding a type of content that can be received by the interactive display system or produced by the interactive display system. The interactive display system is small in size and compact in construction, therefore making said interactive display system portable and effectively be used in a variety of practical use case scenarios.

In a second aspect, the present disclosure provides a computer program product for producing and interacting with a holographic virtual assistant using an interactive display system, the computer program product comprising a non-transitory machine-readable data storage medium having stored thereon program instructions that, when accessed by a processing device, cause the processing device to execute steps of the method of the first aspect.

In the aforementioned computer program product for producing and interacting with the holographic virtual assistant using the interactive display system, the computer program product is beneficially used for managing the interactive display system and other input/output devices in a communication network that is implemented at the environment. The execution of the steps of the method of the first aspect is enabled synergistically by the non-transitory machine-readable data storage medium which is used to store the program instructions, software programs, digital information, that can be read and processed by the interactive display system. Furthermore, the non-transitory machine-readable data storage medium can store in a persistent manner, allowing for long-term retention and retrieval of information.

In a third aspect, the present disclosure provides an interactive display system comprising:
at least one image source;
a holographic optical element that is capable of converting images into holographic images;
a frame designed to accommodate the holographic optical element therein, wherein the frame, in use, arranges the holographic optical element at a first distance from the at least one image source and obliquely with respect to the at least one image source;
at least one sensor; and
a processor operably coupled to the at least one image source and the at least one sensor, wherein the processor is configured to execute steps of the method of any of the claims 1-8.

In the aforementioned interactive display system, the holographic virtual assistant is dynamically produced using the interactive display system based, when the processor of the interactive display system executes the steps of the method of the first aspect for various use case scenarios. Such dynamic controlling is enabled synergistically due to optical properties and design of the holographic optical element, which cause the light rays to have such an optical path, for eventually producing the first image. The holographic element is arranged in the frame, wherein the frame provides structural support to the holographic optical element, and provides extra protection to the holographic optical element from accidental wear and tear. The accommodation of the holographic optical element and the at least one image source in the frame facilitates the interactive display system to be handled in an easy, compact, and sleek manner.

Beneficially, the interactive display system can be used in various environments, i.e., an indoor environment, an outdoor environment. Optionally, the interactive display system works with existing artificial intelligence technology, while simultaneously also employing its own artificial intelligence in some instances. Furthermore, the interactive display system can be used in various domains, which may include, but are not limited to, home-based domain, healthcare domain, manufacturing domain, education domain, retail domain, and hospitality domain. In a first exemplary use case scenario, the interactive display system may be used in the home-based domain, such as, in monitoring and controlling components such as lighting, entertainment systems, appliances, in answering queries, in reminding tasks, in providing a virtual meditation guide session. In a second exemplary use case scenario, the interactive display system may be used in the healthcare domain, such as, in daily healthcare (at home and/or workplace), in surgery, in image analysis for medical diagnosis, in physical therapy. In a third exemplary use case scenario, the interactive display system may be used in the manufacturing domain, such as, for executing manufacturing design of automobile components. In a fourth exemplary use case scenario, the interactive display system may be used in the education domain, such as, in teaching applications, in mentoring applications. In a fifth exemplary use case scenario, the interactive display system may be used in the retail domain, such as, for providing automated responses to the user. In a sixth exemplary use case scenario, the interactive display system may be used in the hospitality domain, such as, for interacting with customers in a restaurant.

Throughout the present disclosure, the term “holographic virtual assistant” refers to a virtual assistant that could be produced in air by using the interactive display system, and with which the user of the interactive display system can interact. Notably, the holographic virtual assistant is a virtual entity (i.e., a non-real entity) which is generated using holographic display technology. Herein, the holographic virtual assistant can be at least one of: a realistic, an animated, an interactive representation of a person, or a character. The holographic virtual assistant can be any one of: a logical instructions-based virtual assistant, an artificial intelligence-based virtual assistant. Herein, the holographic virtual assistant can interact simply based on the logical instructions provided to said holographic virtual assistant, wherein the logical instructions may be predefined scripts and/or limited sets of commands. Alternatively, the holographic virtual assistant can be generated by combining artificial intelligence (AI) technology with holographic virtual assistant, as will be described later. Optionally, the holographic virtual assistant can be used to supplement virtual assistants (such as Siri®, Alexa®, Cortana®, and similar).

Optionally, the holographic virtual assistant is an artificial intelligence-based holographic virtual assistant. Herein, an ability of the holographic virtual assistant to interpret and respond to the at least one interaction input (as will be described later), process natural language, provide relevant (in other words, adaptive) information (i.e., at least one interaction output) based on the at least one interaction input and contextual understanding, and control the interactive display system in an intuitive manner is made possible by employing at least one artificial intelligence algorithm. Resultantly, the artificial intelligence-based holographic virtual assistant is designed to simulate human-like interactions, and provide intelligent interactive assistance to the user based on the at least one interaction input. A technical effect of the holographic virtual assistant being the artificial intelligence-based holographic virtual assistant is that an ability of the holographic virtual assistant to understand, learn, adapt, make decisions and providing personalized experiences to the user is improved when compared to conventional non-AI-based holographic virtual assistant.

Optionally, the method further comprises:
generating interaction training data that is to be used for training the holographic virtual assistant, wherein the interaction training data comprises interaction input data and its corresponding interaction output data;
employing at least one artificial intelligence algorithm for training the holographic virtual assistant using the interaction training data, wherein upon training, the holographic virtual assistant becomes the artificial intelligence-based holographic virtual assistant and the at least one interaction output is generated by the artificial intelligence-based holographic virtual assistant.

A technical effect of training the holographic virtual assistant in such a manner is that the at least one interaction input received by the processor of the interactive display system during the interaction, is analyzed and interpreted accurately by the holographic virtual assistant, thereby enabling the holographic virtual assistant to generate appropriate responses or actions as the at least one interaction output. Herein, the interaction training data is generated by collecting data from at least one data source and then processing the collected data to identify the interaction input data and its corresponding interaction output data. Examples of the data sources may include, but are not limited to, the Internet (using web crawlers), data repositories, reference questionnaires including bilateral communication, historical interaction data of multiple users, and similar. The interaction input data comprises a plurality of reference interaction inputs, and the interaction output data comprises a plurality of reference interaction outputs. Optionally, at least one of the plurality of reference interaction outputs corresponds to a given reference interaction input. In other words, there may be one or more possible outputs for a given input. Alternatively, at least one of the plurality of reference interaction inputs corresponds to a given reference interaction output. In other words, there may be one or more possible inputs for a given output. The holographic virtual assistant may previously be untrained or partially-trained, prior to said training.

Subsequently, a training function is inferred, based on the interaction input data and its corresponding interaction output data, wherein said training function can optionally be applied to existing interaction input data and existing interaction output data to use the holographic virtual assistant as the artificial intelligence-based holographic virtual assistant. Such training functions may be mathematical functions, fuzzy relationships, formulae. The at least one artificial intelligence algorithm used for training the holographic virtual assistant may include, but are not limited to, a machine learning-based algorithm, a deep learning-based algorithm, a natural language processing-based algorithm, and a computer vision-based algorithm. Such artificial intelligence algorithms are well-known in the art. Through the training process, the holographic virtual assistant undergoes supervised learning and incorporates artificial intelligence-based capabilities. This supervised learning enables the non-AI-based holographic virtual assistant to use artificial intelligence-based techniques to enhance functionality and interaction capabilities, thereby transforming into the artificial intelligence-based holographic virtual assistant. It will be appreciated that the holographic virtual assistant is trained at least prior to a beginning of interaction between the holographic virtual assistant and the user of the interactive display system. Additionally, the holographic virtual assistant could also be trained while and/or after the interaction between the holographic virtual assistant and the user of the interactive display system.

Throughout the present disclosure, the term “first image” refers to an image representing the holographic virtual assistant to be displayed by the at least one image source. Herein, the term “image” could be a two-dimensional image or a three-dimensional image. The first image is generated by employing at least one of: a point-cloud technique, a surface-panel technique (namely, a polygon-based technique) a layer-based technique, a three-dimensional perspective projection technique. Such image generation techniques are well-known in the art.

The first image is generated by at least one image source, when several light rays emanating from the at least one image source subsequently converge. Herein, the subsequent convergence is performed by, optionally, a holographic optical element. Notably, optical properties and design of the holographic optical element cause the light rays to have such an optical path, for eventually producing the first image. Optionally, the first image is generated based on, but not limited to, a purpose, an intended audience, a gender of the user, an age of the user. Optionally, the method is implemented by a processor of the interactive display system. Optionally, at least one of: the step of generating the first image, generating the at least one interaction output (as described later), is performed by a server that is communicably coupled to the processor of the interactive display system.

The light rays diverge and pass through the holographic optical element prior to the subsequent convergence of the several light rays emanating from the at least one image source. After passing, the light rays converge in air (or, in mid-air), and form and display the first image right in front of the user. Consequently, the first image generated by the at least one image source appears to be formed in the air, in the form of the holographic virtual assistant.

The at least one interaction input could be received from at least one of: the user, any device associated with the user, a software application, an external trigger. The at least one interaction input can have various forms, which may include, but are not limited to, a voice command, a touch gesture, and a physical movement. The interaction between the holographic virtual assistant and a user of the interactive display system could be a unilateral interaction and/or a bilateral interaction. In an instance, when the interaction between the holographic virtual assistant and the user is unilateral interaction, any one of: the holographic virtual assistant, the user interacts with another one of: the user, the holographic virtual assistant, without expectation of a feedback. In another instance, when the interaction between the holographic virtual assistant and the user is bilateral interaction, the interaction between the holographic virtual assistant and the user is reciprocal in nature.

Optionally, the at least one interaction input is received from at least one of: a sensor arranged in an environment where the interactive display system is used, a device arranged in an environment where the interactive display system is used, a device to which the interactive display system is communicably coupled, an artificial intelligence module of a smart device to which the interactive display system is communicably coupled, a software application executing on a device to which the interactive display system is communicably coupled, another interactive display system that is communicably coupled to the interactive display system. A technical effect of receiving input in such a varied manner is that the interactive display system facilitates functionality in the different domains (as mentioned earlier), and in various use case scenarios. In this regard, the term “environment” refers to a physical location where the interactive display system is utilized. Examples of the environment may include, but are not limited to, a room, a public space, an office building, a theater, a concert hall, and similar.

In some implementations, the sensor is integrated with the interactive display system. In such implementations, the sensor is coupled to the interactive display system (for example, attached via electrical connections to components of the interactive display system). In other implementations, the sensor is implemented on a remote device that is separate from the interactive display system. In such implementations, the sensor is communicably coupled to the interactive display system, wirelessly and/or in a wired manner. Optionally, the sensor is mounted on the remote device. The sensor receives the sensor data (in particular, the at least one interaction input) from the user and sends said sensor data to the interactive display system. Examples of the remote device may include, but are not limited to, a desktop computer, a mobile phone, a tablet, a phablet, a laptop computer, and handheld scanner. The sensor collects sensor data from the environment, which is then received as the at least one interaction input. This sensor data may include, but are not limited to, an audio, an image, a touch, a health metric, and a temperature. Examples of such sensors may include, but are not limited to, an audio sensor (such as, a microphone), an image sensor (such as, a camera), a touch sensor, a biometric sensor, and an environmental sensor (such as, a temperature sensor, a humidity sensor, a dust sensor, and similar).

In some implementations, the device is integrated with the interactive display system. In such implementations, the device is coupled to the interactive display system (for example, attached via mechanical connections and/or electrical connections to components of the interactive display system). In other implementations, the device is implemented on another remote device that is separate from the interactive display system. The device receives the at least one interaction input from the user and sends it to the interactive display system. Examples of the device may include, but are not limited to, a computer, a machine, a home appliance, a robot, and a virtual assistant-based device.

Optionally, the device is arranged external to the environment where the interactive display system is used. Herein, the device is communicably coupled in a wired and/or in a wireless manner. The communication can be carried out the aforementioned manner via any number of known protocols, including, but not limited to, Web Real-Time Communication (WebRTC) protocols, Internet Protocol (IP), Wireless Access Protocol (WAP), Frame Relay, or Asynchronous Transfer Mode (ATM). Moreover, the device can be at least one of: a separate peripheral device, a mobile device, and a remote control.

Optionally, the artificial intelligence module is a software component of the smart device, wherein a neural network of the artificial intelligence module is trained using artificial intelligence algorithms and training data. In other words, the smart device employs artificial intelligence algorithms to perform specialized functions for controlling the smart device. The user interacts with the interactive display system in such a manner that the smart device is controlled via the interactive display system. Examples of the smart device may include, but are not limited to, a smart virtual assistant device (such as Amazon Echo Dot® using Alexa®), a smart speaker, a smart bulb, and a smartphone.

Optionally, the software application may include, but not limited to, a program, an application, and similar that is executed on the device associated with the user. The at least one interaction input is received based on a user action, a user command, base settings, and the like of the device. Additionally, the software application could be a machine learning-based application or a non-machine-learning-based application. The machine learning-based application could be an artificial intelligence-based application. Examples of non-machine learning-based applications may include, but are not limited to, a simple reminder application, a calendar application, and a workspace application.

Optionally, the another interactive display system is any one of: arranged in the environment where the interactive display system is used, arranged external to the environment where the interactive display system is used. The other interactive display system is communicably coupled to the interactive display system in a wired and/or a wireless manner. The other interactive display system functions in a manner similar to the interactive display system.

Continuing in reference to the first exemplary use case scenario, when the interactive display system may be used to provide the virtual meditation guide session, the at least one interaction input may be received from the device with which the interactive display system is communicably coupled. Continuing in reference to the second exemplary use case scenario, when the interactive display system may be used in at least one of: the daily healthcare, for the surgery, the at least one interaction input may be received by a sensor (such as an audio sensor, an optical heart rate sensor, a skin temperature sensor). Continuing in reference to the fourth exemplary use case scenario, when the interactive display system may be used in the mentoring applications, the at least one interaction input may be received by the sensor (such as a touch sensor, an audio sensor). Continuing in reference to the fifth exemplary use case scenario, when the interactive display system may be used for providing automated responses to the user, the at least one interaction input may be received from a software application (such as, a software application corresponding to a retail unit), wherein said software application may be executed on the device (such as, a tablet) which may be communicably coupled to the interactive display system. Continuing in reference to the sixth exemplary use case scenario, when the interactive display system may be used for interacting with customers in the restaurant, the at least one interaction input may be received from another interactive display system.

Optionally, the at least one interaction input is at least one of: a visual input, an audio input, a tactile input, a biometric input, an input pertaining to behavior and/or mood of the user, personal information of the user, a command from a software application, a command from an artificial intelligence module of a smart device to which the interactive display system is coupled. A technical effect of having different types of the at least one interaction input is that it facilitates a natural interaction between the user and the interactive display system. The term “visual input” refers to a visual stimulus that is received and processed by the processor of the interactive display system. The visual input could be provided in a form of images, for example, such as, images of the user, images of the user's surroundings, and similar. The term “audio input” refers to auditory information received by the processor of the interactive display system. The audio input could be provided in a form of voice commands by the user, sounds in the surroundings of the user (for example, such as, sound of a fire alarm, sound of music, and similar), and the like. The term “tactile input” refers to sensory information or stimuli received and processed by the processor of the interactive display system, wherein said sensory information or said stimuli is provided by physical interaction of the user with any sensor or device, communicably coupled to the interactive display system. Examples of the tactile input may include, but are not limited to, touching a touch-sensitive element, touch-based gestures, pressing/toggling physical elements, gripping physical elements, vibrational feedback, and force feedback. The term “biometric input” refers to information or data obtained from measuring unique biological characteristics of the user, wherein the information or the data is captured and processed using biometric technologies. Examples of the biometric input may include, but are not limited to, fingerprint, iris patterns, facial features, voice characteristics, palm print, retina scan, heart rate, electrocardiogram (ECG), gait of the user, EEG (electroencephalogram), and similar. The phrase “input pertaining to behavior and/or mood of the user” refers to information or data related to at least one of: an action, a conduct, an emotional state of the user using the interactive display system. Examples of such input may include, but are not limited to, expressions, micro-expressions, voice inflections, tonality, a rate of heartbeat, and body movement. The phrase “personal information of the user” refers to data or information which can be used to directly or indirectly identify the user, wherein said information is associated with personal identity, characteristics, or attributes of the user. The personal information of the user may include, but is not limited to, personal data of the user, preferences of the user, and historical interaction data of the user.

Furthermore, the phrase “command from a software application” refers to a particular instruction or a set of instructions that is designed for the software application to execute via the processor of the interactive display system. The software application may be a program or a software system with which the user interacts with. Optionally, the command is in the form of text commands, voice commands, and button clicks. Examples of commands from the software application may include, but are not limited to, playing music at a particular time, turning on an air conditioner upon sensing the user's presence, and turning on the sprinkler system of a garden when ambient temperature lies in a predefined temperature range. Examples of the software application may include, but are not limited to, a mobile application, a web application, and a desktop software application.

Continuing in reference to the first exemplary use case scenario, the at least one interaction input during the virtual meditation guide session may be the visual input, the audio input, and/or the input pertaining to behavior and/or mood of the user. Continuing in reference to the second exemplary use case scenario, the at least one interaction input during: the daily healthcare of the user may be the biometric input, for the surgery may be the audio input, for the image analysis may be visual input, for the physical therapy may be the biometric input and the personal information of the user. Continuing in reference to the fourth exemplary use case scenario, the at least one interaction input may be the audio input, the tactile input, the personal information of the user. Continuing in reference to the fifth and the sixth exemplary use case scenarios, the at least one interaction input may be the audio input.

Optionally, the interaction between the holographic virtual assistant and the user of the interactive display system pertains to at least one of: a response of the holographic virtual assistant to a query or a statement of the user, a reminder from the holographic virtual assistant to the user, a tutorial provided by the holographic virtual assistant to the user, an instruction provided by the holographic virtual assistant to the user, an experience provided by the holographic virtual assistant for the user. A technical effect of such an interaction is that, it enables the user to at least one of: obtain information, assistance, perform tasks through the interactive display system, by interacting with the holographic virtual assistant.

Optionally, the query or the statement of the user may be in the form of a text, a voice command, a gesture, a touch, and similar, initiated by the user to the holographic virtual assistant, to which the holographic virtual assistant responds to. Herein, a query could be a question requesting for information, a request for performing an action, and the like. The statement could be an expression of a need, a command, or an expression of intent. The holographic virtual assistant processes the query or the statement of the user, and provides the response accordingly. The response can be in the form of a visual response (for example, such as present text, presenting images, emitting light, and the like), an audio response, a vibration response, and similar. The response could be formulated in real time by the holographic virtual assistant based on the query or the statement, or could be automated. The response of the holographic virtual assistant is lag-free. A technical effect of this type of interaction is that it enables the user to engage in a natural, meaningful and dynamic manner with the holographic virtual assistant.

Continuing in reference to the first exemplary use case scenario, a statement of the user may be “Let us start with meditation”, and a response of the holographic virtual assistant to the query may be to start the virtual meditation guide session. Continuing in reference to the fifth exemplary use case scenario, a query of the user may be to know a location of a shop in a shopping mall, and a response of the holographic virtual assistant to the query may be to provide the user with directions to said shop. Continuing in reference to the sixth exemplary use case scenario, a query of the user may be “What are today's specials?”, and a response of the holographic virtual to the query may be to list out the specials food items in the menu.

Optionally, the reminder is provided by the holographic virtual assistant even when at least one interaction input is not received from the user. The reminder can be provided to the user in the form of a notification, a prompt, an email, a message, an alarm, and similar to remind the user about upcoming appointments, deadlines, important messages, tasks, and similar, of the user. The reminder can be set by the user manually, learnt by a trained holographic virtual assistant by observing a routine of the user, and/or a combination of both. The reminder is received from the holographic virtual assistant in a timely manner, and without any delay. A technical effect of interacting using the reminder is that it enables the users to make a judicious use of their time.

Continuing in reference to the first exemplary use case scenario, the holographic virtual assistant may remind the user of the tasks to be performed. Continuing in reference to the second exemplary use case scenario, during the daily healthcare, the holographic virtual assistant may remind the user to take medications and/or exercise at particular time instants. Continuing in reference to the fourth exemplary use case scenario, the holographic virtual assistant may provide assignment deadline reminders, homework reminders, class reminders, upcoming test reminders. Continuing in reference to the sixth exemplary use case scenario, the holographic virtual assistant may provide reminders regarding favorite food of the user at a particular restaurant.

Optionally, the tutorial is provided by the holographic virtual assistant upon receiving at least one interaction input from the user, or can be automatically provided by the holographic virtual assistant at a particular time and instant. The tutorial could be a step-by-step explanation, a demonstration, a visual aid, and the like to facilitate a user in understanding and learning how to perform a particular task. A technical effect of interacting using the tutorial is that it enables real-time communication to one user, or many users, simultaneously. Continuing in reference to the second exemplary use case scenario, during a session of the physical therapy, a tutorial of exercises to be performed during the session may be provided to the user. Continuing in reference to the fourth exemplary use case scenario, concepts of subjects may be provided as tutorials to the user.

Optionally, the instruction is provided by the holographic virtual assistant upon receiving at least one interaction input from the user, or can be automatically provided by the holographic virtual assistant at a particular time and instant. The instruction provided by the holographic virtual assistant could be regarding how to perform a particular task, how to accomplish a particular goal, navigation through a particular process. The instructions could be provided as a flowchart, a pictorial representation of the instructions, a video of the instructions, voice commands, haptic feedback, and the like. A technical effect of interacting using the instruction is that it facilitates the user to efficiently and accurately complete a task or an action through the interactive display system, by following a guidance provided by the holographic virtual assistant. Continuing in reference to the second exemplary use case scenario, during the daily healthcare, healthcare education materials can be provided as easy-to follow instructional videos.

Optionally, the experience provided by the holographic virtual assistant for the user is in the form of at least one of: an animation of an experience, a tactile experience, a visual experience. The experience provided by the holographic virtual assistant ensures that the user is engaged, entertained, or informed, through the interactive display system. Examples of the experience may include, but are not limited to, an immersive experience (such as a meditation experience), an education experience, an interactive storytelling, and an entertainment content. A technical effect of interacting using the experience provided by the holographic virtual assistant is that it engages the user, thereby enhancing user experience. Continuing in reference to the first exemplary use case scenario, the home educational experiences may be animated for children. Continuing in reference to the fourth exemplary use case scenario, educational programs may be animated as a character of the user's choice, such as a princess, a prince, and the like.

The processor of the interactive display system generates the at least one interaction output, wherein the at least one interaction output can be in a form of at least one of: a visual information, an audio feedback, a haptic feedback, a textual response. The at least one interaction output is generated in a lag-free manner. In an instance, the generation of the at least one interaction output is non-artificial intelligence-based. In this regard, the at least one interaction output may be fetched corresponding to the at least one interaction input from a lookup table, a formula may be used to determine the at least one interaction output, simple pre-programmed instructions may be executed, pre-programmed rule-based routines may be executed, and similar. In another instant, the generation of the at least one interaction output is artificial intelligence-based, which has been described below.

Optionally, the at least one interaction output comprises at least one of:
a second image of at least one of: the holographic virtual assistant, a holographic virtual object;
an audio output;
a light output;
a tactile output.

A technical effect having such different types of the at least one interaction output is that the holographic virtual assistant provides a natural interaction, which further facilitates an immersive and an engaging experience for the user. In this regard, the second image is generated in a manner similar to the generation of the first image. The second image could be a single image, or a plurality of second images updated on a frame-by-frame basis. The second image of the holographic virtual assistant is different from the first image of the holographic virtual assistant, as the second image is the at least one interaction output which is generated after analyzing the at least one interaction input received by the processor of the interactive display system. The term “holographic virtual object” refers to a digital representation of an object that is presented as a hologram in the environment, wherein such object is not physically present in the environment where the interactive display system is used. Such holographic virtual objects are typically created using three-dimensional modeling techniques, and can be designed to appear three-dimensional, interactive and responsive when interacting with the user. Examples of such holographic virtual objects may include, but are not limited to, virtual diagrams, virtual descriptions, virtual images, virtual videos (for example, such as virtual tutorials, virtual tours of places, and the like), virtual graphical illustrations, virtual lighting devices, virtual furniture, virtual vehicles or their parts, virtual maps, virtual navigation assistants, virtual books, virtual tools, virtual industrial equipment or their parts, virtual environment, the virtual model of anatomical parts, virtual blueprints, virtual concierge, a virtual ticketing assistant, a digital twin representing a person, a physical object, system, or process, virtual industrial equipment (for example, such as virtual industrial tools or their parts), virtual industrial machines or their parts, and similar.

Continuing in reference to the first exemplary use case scenario, when the interactive display system provides the virtual meditation guide session, the at least one interaction output may be a spatial arrangement of virtual images, a virtual video, and similar. Continuing in reference to the second exemplary use case scenario, the at least one interaction output: during the daily healthcare of the user may be the virtual book representing an instruction manual, for the surgery may be the digital twin representing a person or a three-dimensional augmented reality virtual model of the anatomical parts, for image analysis may be three-dimensional virtual model of the anatomical parts, for physical therapy may be the virtual videos of exercises to be performed. Continuing in reference to the third exemplary use case scenario, the at least one interaction output may be the virtual industrial equipment, virtual vehicles or their parts, and/or the virtual industrial machines or their parts. Continuing in reference to the fourth exemplary use case scenario, the at least one interaction output may be the holographic virtual assistant as a cartoon character, the virtual books, the virtual videos, and similar. Continuing in reference to the fifth exemplary use case scenario, the at least one interaction output may be the virtual maps, the virtual navigation assistants, the virtual descriptions, and/or the virtual blueprints. Continuing in reference to the sixth exemplary use case scenario, the at least one interaction output may be the virtual concierge, and/or the virtual ticketing assistant.

Furthermore, the term “audio output” refers to auditory information presented by the interactive display system. Examples of the audio output may include, but are not limited to, answers to queries, responses to statements, music, sounds of living and non-living objects, voice of a character, audiobooks, voice commands, audio instructions, audio recommendations, a sound (for example, such as a notification sound, an alarm). Continuing in reference to the second exemplary use case scenario, during the physical therapy, the audio output may be used to explain exercises if a session of the physical therapy is conducted virtually. Continuing in reference to the fifth exemplary use case scenario, directions of a particular shop in the shopping mall may be provided to the user as the audio output. Continuing in reference to the sixth exemplary use case scenario, the specials in the menu may be provided to the user as the audio input.

Additionally, the term “light output” refers to an amount and/or intensity of light produced by the interactive display system. The light output could be provided via light-emitting diodes, laser-based systems, light bulbs, display of the devices, and similar. The light output could be in a form of, but not limited to, a pattern, a particular intensity, a particular brightness, a particular direction. Continuing in reference to the first exemplary use case scenario, during the virtual meditation guide session, the light output may be controlled to provide an immersive meditation experience to the user.

Moreover, the term “tactile output” refers to physical feedback generated by the processor of the interactive display system to provide a touch experience or a haptic experience to the user. The tactile output could be in a form of, but not limited to, a vibration, a tapping, a pattern of tapping, a texture variation, force feedback, pressure feedback, kinaesthetic feedback, and electrostatic feedback. Continuing in reference to the second exemplary use case scenario, during the daily healthcare, a heartbeat type vibration may be provided when a heart rate of the user exceeds a reference heart rate.

The interactive display system is controlled via the processor to deliver (i.e., provide) the at least one interaction output to the user. The processor could send instructions and/or signals (for example, such as a voltage signal, a current signal) to output devices (as described later) communicably coupled to the interactive display system, to provide the at least one interaction output to the user. The interactive display system is controlled in such a manner that a proper timing and synchronization of the at least one interaction output is maintained, thereby providing a seamless user experience.

Optionally, the step of controlling the interactive display system to provide the at least one interaction output to the user comprises at least one of:
displaying the second image using at least one image source of the interactive display system, wherein upon displaying, the at least one of: the holographic virtual assistant, the holographic virtual object, is produced in air when light rays emanating from the at least one image source pass through a holographic optical element of the interactive display system;
playing the audio output using at least one speaker of the interactive display system;
controlling at least one light-output device of the interactive display system to emit a given light;
controlling at least one tactile output device of the interactive display system to provide the tactile output.

A technical effect of controlling the interactive display system in such a manner is that visual, auditory, lighting, and tactile elements when used individually or in a combination thereof, can provide the user with a realistic, immersive and an engaging interaction with the interactive display system. Herein, the output devices are the at least one image source, the at least one speaker, the at least one light-output device, the at least one tactile output device, wherein said output devices are communicably coupled to the interactive display system. Optionally, the output devices are arranged in the environment where the interactive display system is used, or arranged external to said environment.

In a first instance, when the second image is displayed using the at least one image source, the light rays emanating from the at least one image source are refracted by the holographic optical element. Furthermore, the light rays undergo reflection within the holographic optical element and upon exiting, produces at least one of: the holographic virtual assistant, the holographic virtual object in the form of the second image.

In a second instance, when the audio output is played using the at least one speaker, the processor sends audio-related signals (i.e., voltage signals and/or current signals) to the at least one speaker, which then converts said audio-related signals to produce sound waves. In some implementations, the at least one speaker is integrated with the interactive display system. In such implementations, the at least one speaker is coupled to the interactive display system. In other implementations, the is implemented separately from the interactive display apparatus. In such implementations, the at least one speaker is communicably coupled with the interactive display system. In yet other implementations, the at least one speaker is implemented on yet another remote device that is separate from the interactive display system. The at least one speaker is communicably coupled with the interactive display system. The interactive display system uses the at least one speaker for playing the audio output. Optionally, the interactive display system employs one speaker or multiple speakers to play the audio output. When the interactive display system employs multiple speakers, said multiple speakers are arranged in a manner so as to facilitate stereo sound experience or surround sound experience, thereby providing an immersive experience to the user. Optionally, the interactive display unit may control at least one of: a playback, a volume, an effect, equalization of the audio output.

In a third instance, when the given light is emitted by controlling the at least one light-output device, the processor sends light-related signals (i.e., other voltage signals and/or other current signals) to the at least one light-output device. In some implementations, the at least one light-output device is integrated with the interactive display system. In such implementations, the at least one light-output device is coupled to the interactive display system. In other implementations, the at least one light-output device is implemented separately from the interactive display apparatus. In such implementations, the at least one light-output device is communicably coupled with the interactive display system. In yet other implementations, the at least one light-output device is implemented on still another remote device that is separate from the interactive display system. The at least one light-output device is communicably coupled with the interactive display system. The interactive display system uses the at least one light-output device for emitting the given light. Optionally, the at least one light-output device controls at least one of: the pattern, the particular intensity, the particular brightness, the particular direction, of the given light that is emitted. As an example, the light-output device may be a light-emitting diode (LED), wherein said LED can emit different colors for true or false, or right or wrong statements from the user. As another example, the at least one light-output device may be a seven-segment display, wherein said seven-segment display may depict scores given to a user based on a given interaction input.

In a fourth instance, when the at least one tactile output is provided by controlling the at least one tactile output device, the processor sends tactile-related signals (i.e., yet other voltage signals and/or yet other current signals) to the output device. In some implementations, the at least one tactile output device is integrated with the interactive display system. In such implementations, the at least one tactile output device is coupled to the interactive display system. In other implementations, the at least one tactile output device is implemented separately from the interactive display apparatus. In such implementations, the at least one tactile output device is communicably coupled with the interactive display system. In yet other implementations, the at least one tactile output device is implemented on yet another remote device that is separate from the interactive display system. The at least one tactile output device is communicably coupled with the interactive display system. The interactive display system uses the at least one tactile output device for providing the at least one tactile output. The at least one tactile output device could optionally control the vibration, the tapping, the pattern of tapping, the texture variation, the force feedback, the pressure feedback, the kinaesthetic feedback, and the electrostatic feedback provided to the user.

In an exemplary use case, there may be an environment in which the interactive display system may be used for the purpose of education in automobile engineering. The environment is shown to include therein, an interactive display system, a user who uses the interactive display system, a device, and a car (about which the education is to be imparted to the user, in this exemplary use case). The device is communicably coupled with the interactive display system. The user may interact with the interactive display system by providing an interaction input (for example, such as an audio input) to the device. The device may receive the audio input from the user and may send it to the interactive display system. The audio input may be a query of the user regarding the car. The query may, for example, be “What are the features and parts of this car?”. Then, the interactive display system may interact with the user by providing at least one interaction output. The at least one interaction output may be generated, for example, based on the query of the user, by the interactive display system. The at least one interaction output may comprise a second image of at least one of: the holographic virtual assistant, the holographic virtual object (for example, such as a virtual diagram of the car), and an audio output. The second image is displayed using at least one image source of the interactive display system, wherein upon displaying, the holographic virtual assistant and the virtual diagram may be produced. A plurality of such second images may be generated wherein the virtual diagram may be updated on a frame-by-frame basis. The audio output may be played using a speaker of the interactive display system (for example, such as a speaker of the device to which the interactive display system is coupled). The audio output may be a response to the query of the user, wherein said response, may for example be, an explanation of features and parts of the car.

The present disclosure also relates to the second aspect as described above. Various embodiments and variants disclosed above, with respect to the aforementioned first aspect, apply mutatis mutandis to the second aspect.

The computer program product for producing and interacting with a holographic virtual assistant using an interactive display system, the computer program product comprising a non-transitory machine-readable data storage medium having stored thereon program instructions that, when accessed by a processing device, cause the processing device to execute steps of the aforementioned method. The term “computer program product” refers to a software product comprising program instructions that are recorded on the non-transitory machine-readable data storage medium, wherein the software product is executable upon a computing hardware for implementing the aforementioned steps of the method for managing devices in a communication network that is implemented at a premises.

In an embodiment, the non-transitory machine-readable data storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

The present disclosure also relates to the third aspect as described above. Various embodiments and variants disclosed above, with respect to the aforementioned first aspect, apply mutatis mutandis to the third aspect.

The at least one image source could be a display of a display device, a transmissive projection surface associated with a projector, and the like. Herein, the display could be a two-dimensional display or a three-dimensional display. Optionally, the display device is implemented as a volumetric display device, wherein the volumetric display device forms a visual representation of any object in three physical dimensions. The at least one image source emits light rays of a predefined wavelength, wherein said predefined wavelength comprises any one of: a particular wavelength, a range of wavelengths.

The holographic optical element utilizes holographic technology to manipulate the light rays emanating from the at least one image source. Optionally, the holographic optical element comprises at least two layers of reflective elements stacked on top, wherein each of the at least two layers are stacked in different directions. The light rays undergo reflection and refraction after striking each of the at least two layers. In this regard, the light rays emitted from the at least one image source diverge and pass through the holographic optical element. Herein, the holographic optical element refracts the light rays, and undergoes reflection when passing through the holographic optical element. The holographic optical element could be made of glass, plastic, and other refractive materials.

The holographic optical element and the at least one image source are accommodated in the frame. Herein, the frame, when in use, arranges the holographic optical element at the first distance from the at least one image source, wherein the first distance is the distance between the at least one image source and the holographic optical element. Moreover, the frame holds the holographic optical element at an angle such that the light rays emanating from the at least one image source properly strike the holographic optical element. Furthermore, the frame holds the at least one image source at another angle, wherein the another angle between the frame and the at least one image source lies in a range of 30 degrees to 90 degrees. The other angle between the frame and the at least one image source lies in a range of 30, 35, 45, 55, or 75 degrees to 40, 50, 70, 80, 85, or 90 degrees. Moreover, the frame could be made out of plastic, durable alloy, metal and the like.

The processor of the interactive display system is implemented as hardware, software, firmware, or a combination of these. As an example, the processor may control the at least one image source to emit light constituting the first image. The processor may further be configured to perform other processing task(s) that may include, but are not limited to, manipulating (for example, adjusting a shape, size, a color, and the like) at least a portion of the first image, zooming-into or zooming-out of the first image, controlling an output device to provide at least one interaction output, turning off the interactive display system, transforming two-dimensional images into three-dimensional images.

It will be appreciated that the components of the interactive display system as described in detail in the U.S. patent application Serial Number U.S. Ser. No. 17/554,311, titled “INTERACTIVE DISPLAY SYSTEM AND METHOD FOR INTERACTIVELY PRESENTING HOLOGRAPHIC IMAGE” and filed on Dec. 17, 2021, whose text has been fully incorporated by reference.

### DETAILED DESCRIPTION OF THE DRAWINGS

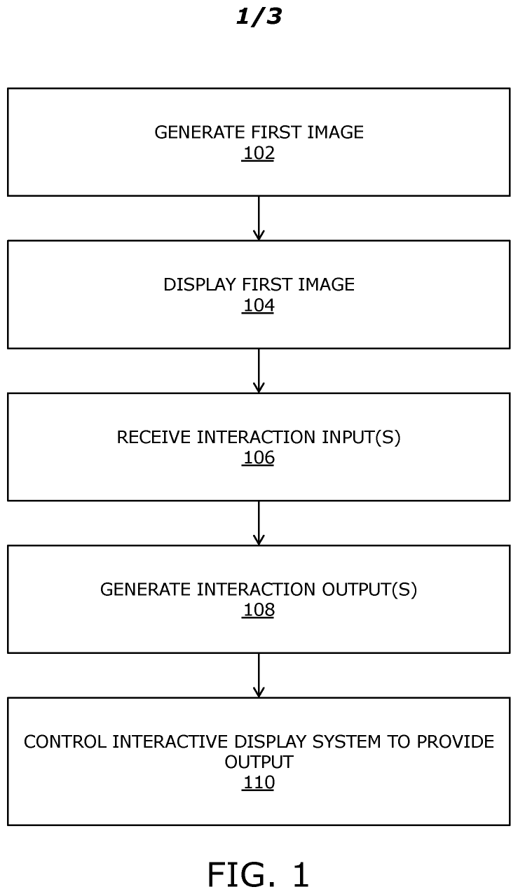

Referring to FIG. 1, illustrated is a flowchart depicting steps of a method for producing and interacting with a holographic virtual assistant using an interactive display system, in accordance with an embodiment of the present disclosure. At step 102, a first image of the holographic virtual assistant is generated. At step 104, the first image is displayed using the interactive display system, wherein upon displaying, the holographic virtual assistant is produced in air. At step 106, at least one interaction input pertaining to an interaction between the holographic virtual assistant and a user of the interactive display system is received. At step 108, at least one interaction output is generated, based on the at least one interaction input. At step 110, the interactive display system is controlled to provide the at least one interaction output to the user.

The aforementioned steps are only illustrative and other alternatives can also be provided where one or more steps are added, one or more steps are removed, or one or more steps are provided in a different sequence without departing from the scope of the claims herein.

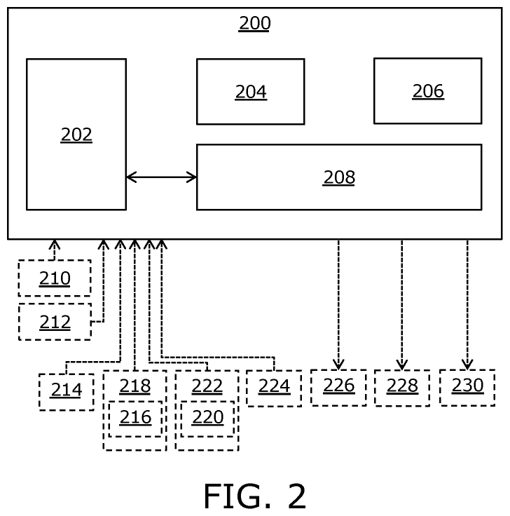

Referring to FIG. 2, illustrated is a block diagram of an architecture of an interactive display system 200, in accordance with an embodiment of the present disclosure. The interactive display system 200 comprises at least one image source (depicted as an image source 202), a holographic optical element 204, a frame 206 designed to accommodate the holographic optical element 204 therein, and a processor 208. The image source 202 is used for displaying images, the holographic optical element 204 is capable of converting the images into holographic images, the frame 206 in use, arranges the holographic optical element 204 at a first distance from the image source 202 and obliquely with respect to the image source 202, and the processor 208 is operably coupled to the image source 202. The processor 208 is configured to perform various operations, as described earlier with respect to the aforementioned first aspect.

Optionally, at least one interaction input is received from at least one of: a sensor 210 arranged in an environment where the interactive display system 200 is used, a device 212 arranged in the environment where the interactive display system 200 is used, a device 214 to which the interactive display system 200 is communicably coupled, an artificial intelligence module 216 of a smart device 218 to which the interactive display system 200 is communicably coupled, a software application 220 executing on a device 222 to which the interactive display system 200 is communicably coupled, another interactive display system 224 that is communicably coupled to the interactive display system 200. The sensor 210, the device 212, the device 214, the artificial intelligence module 216 of the smart device 218, the software application 220 executing on the device 222, the another interactive display system 224, are communicably coupled to the interactive display system 200 (and in particular, to the processor 208 of the interactive display system 200).

Optionally, at least one interaction output is provided from at least one of: the image source 202, at least one speaker (depicted as a speaker 226), at least one light-output device (depicted as a light-output device 228), at least one tactile output device (depicted as a tactile output device 230). The image source 202, the speaker 226, the light-output device 228, and the tactile output device 230 are communicably coupled to the interactive display system 200 (and in particular, to the processor 208 of the interactive display system 200).

FIG. 2 is merely an example, which should not unduly limit the scope of the claims herein. A person skilled in the art will recognize many variations, alternatives, and modifications of embodiments of the present disclosure.

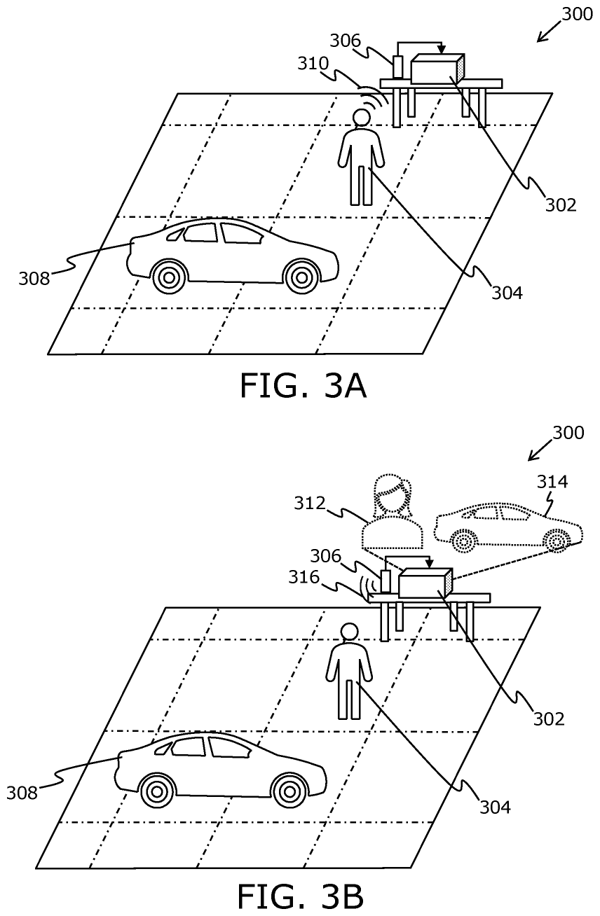

Referring to FIGS. 3A and 3B, illustrated are exemplary perspective views of an environment 300 in which an interactive display system 302 is used, in accordance with an embodiment of the present disclosure. FIGS. 3A and 3B illustrate an exemplary use case scenario of using the interactive display system 302 for the purpose of education in automobile engineering. In FIGS. 3A and 3B, the environment 300 is shown to include therein an interactive display system 302, a user 304 who uses the interactive display system 302, a device 306, and a car 308 (about which the education is to be imparted to the user 304, in this exemplary use case). The device 306 is communicably coupled with the interactive display system 302. Herein, internal components of the interactive display system 302 are not shown for sake of simplicity.

In FIG. 3A, the user 304 interacts with the interactive display system 302 by providing an interaction input (depicted as an audio input 310) to the device 306. The device 306 receives the audio input 310 from the user 304 and sends it to the interactive display system 302. The audio input 310 may be a query of the user 304 regarding the car 308. The query may, for example, be “What are the features and parts of this car?”.

In FIG. 3B, the interactive display system 302 interacts with the user 304 by providing at least one interaction output. The at least one interaction output is generated, for example, based on the query of the user 304, by the interactive display system 302. The at least one interaction output comprises a second image of at least one of: a holographic virtual assistant 312, a holographic virtual object (depicted as a virtual diagram 314 of the car 308), and an audio output 316. The second image is displayed using at least one image source (not shown) of the interactive display system 302, wherein upon displaying, the holographic virtual assistant 312 and the virtual diagram 314 are produced in air when light rays emanating from the at least one image source pass through a holographic optical element (not shown) of the interactive display system 302. For example, a plurality of such second images may be generated wherein the virtual diagram 314 may be updated on a frame-by-frame basis. The audio output 316 is played using a speaker of the interactive display system 302 (such as a speaker of the device 306 to which the interactive display system 302 is coupled). The audio output 316 is a response to the query of the user 304, wherein said response, is for example, an explanation of features and parts of the car 308.

FIGS. 3A-3B are merely an example, which should not unduly limit the scope of the claims herein. A person skilled in the art will recognize many variations, alternatives, and modifications of embodiments of the present disclosure.

What is claimed is:

1. A method for producing and interacting with a holographic virtual assistant using an interactive display system, the method comprising:
generating a first image of the holographic virtual assistant;
displaying the first image using the interactive display system, wherein upon displaying, the holographic virtual assistant is produced in air;
receiving at least one interaction input pertaining to an interaction between the holographic virtual assistant and a user of the interactive display system;
generating at least one interaction output, based on the at least one interaction input; and
controlling the interactive display system to provide the at least one interaction output to the user.

2. The method of claim 1, wherein the holographic virtual assistant is an artificial intelligence-based holographic virtual assistant.

3. The method of claim 2, further comprising:
generating interaction training data that is to be used for training the holographic virtual assistant, wherein the interaction training data comprises interaction input data and its corresponding interaction output data;
employing at least one artificial intelligence algorithm for training the holographic virtual assistant using the interaction training data, wherein upon training, the holographic virtual assistant is transformed into the artificial intelligence-based holographic virtual assistant and the at least one interaction output is generated by the artificial intelligence-based holographic virtual assistant.

4. The method of any of the preceding claims, wherein the at least one interaction input is received from at least one of: a sensor arranged in an environment where the interactive display system is used, a device arranged in an environment where the interactive display system is used, a device to which the interactive display system is communicably coupled, an artificial intelligence module of a smart device to which the interactive display system is communicably coupled, a software application executing on a device to which the interactive display system is communicably coupled, another interactive display system that is communicably coupled to the interactive display system.

5. The method of any of the preceding claims, wherein the at least one interaction input is at least one of: a visual input, an audio input, a tactile input, a biometric input, an input pertaining to behavior and/or mood of the user, personal information of the user, a command from a software application, a command from an artificial intelligence module of a smart device to which the interactive display system is coupled.

6. The method of any of the preceding claims, wherein the interaction between the holographic virtual assistant and the user of the interactive display system pertains to at least one of: a response of the holographic virtual assistant to a query or a statement of the user, a reminder from the holographic virtual assistant to the user, a tutorial provided by the holographic virtual assistant to the user, an instruction provided by the holographic virtual assistant to the user, an experience provided by the holographic virtual assistant for the user.

7. The method of any of the preceding claims, wherein the at least one interaction output comprises at least one of:
a second image of at least one of: the holographic virtual assistant, a holographic virtual object;
an audio output;
a light output;
a tactile output.

8. The method of claim 7, wherein the step of controlling the interactive display system to provide the at least one interaction output to the user comprises at least one of:
displaying the second image using at least one image source of the interactive display system, wherein upon displaying, the at least one of: the holographic virtual assistant, the holographic virtual object, is produced in air when light rays emanating from the at least one image source pass through a holographic optical element of the interactive display system;
playing the audio output using at least one speaker of the interactive display system;
controlling at least one light-output device of the interactive display system to emit a given light;
controlling at least one tactile output device of the interactive display system to provide the tactile output.

9. A computer program product for producing and interacting with a holographic virtual assistant using an interactive display system, the computer program product comprising a non-transitory machine-readable data storage medium having stored thereon program instructions that, when accessed by a processing device, cause the processing device to execute steps of the method of any of the claims 1-8.

10. An interactive display system comprising:
at least one image source for displaying images;
a holographic optical element that is capable of converting the images into holographic images;
a frame designed to accommodate the holographic optical element therein, wherein the frame, in use, arranges the holographic optical element at a first distance from the at least one image source and obliquely with respect to the at least one image source; and
a processor operably coupled to the at least one image source, wherein the processor is configured to execute steps of the method of any of the claims 1-8.
